(19) United States
(12) Patent Application Publication
(10) Pub. No.: US 2007/0132656 A1
(43) Pub. Date: Jun. 14, 2007

(54) ANTENNA INCORPORATING POLAR LIQUID

(75) Inventors: JONG LAE KIM, DAEJEON (KR); DONG HYUN KIM, KYUNGKI-DO (KR); HYUN HAK KIM, KYUNGKI-DO (KR); II HWAN PARK, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/456,515

(22) Filed: Jul. 10, 2006

(30) Foreign Application Priority Data
Jul. 11, 2005 (KR) 10-2005-62352
Aug. 2, 2005 (KR) 10-2005-70730

(51) Int. Cl. H01Q 1/36

(52) U.S. Cl. 343/895; 343/700 MS

(57) ABSTRACT

A novel structure of antenna includes a polar liquid, a container made of an insulating material and containing the polar liquid, and a feeder connected to the polar liquid contained in the container. Then, the polar liquid acts as a radiator. A wideband antenna includes a radiator constructed of a conductor having an electrical resonant length corresponding to a unique resonant frequency. The radiator having a feeder at one end connected to an outer circuit. A container made of an insulating material contains at least a portion of the radiator therein or disposed adjacent to a portion of the radiator, and a polar liquid contained inside the container affects electromagnetic flow of the radiator in order to change the unique resonant frequency of the radiator.

### CLAIM OF PRIORITY

This application claims the benefit of Korean Patent Applications No. 2005-62352 on Jul. 11, 2005 and No. 2005-70730 on Aug. 2, 2005, in the Korean Intellectual Property Office, the disclosure of which is incorporated herein by reference.

### BACKGROUND OF THE INVENTION

1. Field of the Invention

The present invention relates to an antenna, and more particularly, a novel concept of antenna which incorporates polar liquid such as water to easily achieving the resonant frequency in a wide band.

2. Description of the Related Art

In general, an antenna is constructed of a dielectric or magnetic body and a conductor patterned on the body. Such an antenna has a unique resonant frequency determined by the conductor structure and the dielectric constant of the dielectric body. As known, with the conductor or dielectric material determined to specific properties, the resonant frequency cannot be adjusted until the geometry of the conductor body is changed.

Recent mobile communication terminals need a compact antenna in which the resonant frequency can be adjusted in a wide band and/or to a low band. As an approach, there have been attempts to fabricate a compact antenna of a low bandwidth by using a magnetic material with minimized resistance. However, it is still difficult to achieve a sufficient resonant length for the antenna when installed in a mobile communication terminal that affords merely a limited space for the antenna.

FIG. 1 shows a conventional chip antennal 10 having a microstrip structure.

Referring to FIG. 1, the chip antenna 10 having a microstrip structure includes a dielectric block 11 and a conductor pattern 15 in the form of a meander line. Such a chip antenna 10 has a unique resonant frequency determined by the resonant length of the conductor pattern 15.

In order to adjust the resonant frequency, the geometry and length of the conductor pattern 15 should be changed. As the size of the conductor pattern 15 should be increased to lower the bandwidth of the resonant frequency, a limited space makes it difficult.

Although a typical antenna generally covers merely a narrow bandwidth, a wide bandwidth is more preferable in some cases even if the gain is less. Ideally, it might be most advantageous if the antenna can cover all bandwidths while maintaining high gain. However, such merits are rarely achievable from conventional antennas that adopt a conductive radiator.

Since the conventional antennas such as a chip antenna adopt a conductor adopted as a radiator as stated above, neither the resonant frequency neither is adjustable easily nor the antennas are applicable to wideband and/or low-band use.

### SUMMARY OF THE INVENTION

The present invention has been made to solve the foregoing problems of the prior art and therefore an object of certain embodiments of the present invention is to provide a novel antenna which adopts polar liquid as a novel radiator in place of conventional conductors to easily adjust the resonant frequency in a wide band.

Another object of the present invention is to provide a novel antenna which has polar liquid combined with a conductive radiator to adjust the resonant frequency without extension or modification of a conductor structure.

According to an aspect of the invention for realizing the object, there is provided an antenna comprising: a polar liquid; a container made of an insulating material, the container containing the polar liquid; and a feeder connected to the polar liquid contained in the container, whereby the polar liquid acts as a radiator.

Preferably, the polar liquid that may be adopted in the invention may comprise one selected from the group consisting of water, methanol, ethanol, butanol, acetonitril, acetone, SAR solution and mixtures thereof.

In order to introduce additional electromagnetic influence, the polar liquid may comprise an electrolyte solution with at least one type of electrolyte solved therein, and separately or cooperatively may contain conductor powder that is attractable by magnetic force, in which the conductor powder may comprise Fe.

According to another aspect of the invention for realizing the object, there is provided a wideband antenna comprising: a radiator constructed of a conductor having an electrical resonant length corresponding to a unique resonant frequency, the radiator having a feeder at one end connected to an outer circuit; a container made of an insulating material, the container containing at least a portion of the radiator therein or disposed adjacent to a portion of the radiator; and a polar liquid contained inside the container, the polar liquid affecting electromagnetic flow of the radiator in order to change the unique resonant frequency of the radiator.

Optionally, the whole part of the radiator may be arranged inside the container.

According to an embodiment of the invention, the radiator may be helical, in which the polar liquid enables the antenna to have a resonant frequency higher than unique resonant frequency of the radiator.

According to another embodiment of the invention, the radiator may have a monopole configuration, in which the polar liquid enables the antenna to have a resonant frequency higher than unique resonant frequency of the radiator.

According to further another embodiment of the invention, the wideband antenna may be a chip antenna, in which the container is shaped to surround at least a portion of the chip antenna. Furthermore, the radiator of the chip antenna may be formed as a conductor pattern on a surface of the container.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic perspective view illustrating a conventional chip antenna;

FIG. 2 is a schematic perspective view illustrating an antenna incorporating a liquid radiator according to the invention;

FIGS. 3a to 3c are simulation graphs illustrating reflection coefficient characteristics according to filling conditions of the antenna shown in FIG. 2;

FIGS. 4a and 4b are schematic perspective views illustrating liquid-coupled monopole and helical antennas according to the invention;

FIG. 5 is a schematic perspective view illustrating an assembly of a monopole antenna and a helical antenna according to an embodiment of the invention;

FIG. 6 is a schematic perspective view illustrating a quarter wavelength microstrip antenna structure according to an embodiment of the invention;

FIGS. 7a to 7c are graphs illustrating reflection coefficient characteristics of antennas each fabricated according to the invention in order to measure resonant frequency characteristics thereof;

FIGS. 8a and 8c are graphs illustrating radiation patterns of antennas each fabricated according to the invention in order to measure resonant frequency characteristics thereof;

FIGS. 9a and 9b are graphs illustrating reflection coefficient characteristics and radiation patterns of antennas which uses carbonated water as a polar liquid according to the invention;

FIGS. 10a and 10b are graphs illustrating reflection coefficient characteristics of a monopole antenna configured similar to that shown in FIG. 4a;

FIGS. 11a and 11b are graphs illustrating reflection coefficient characteristics of a helical antenna configured similar to that shown in FIG. 4b; and

FIGS. 12a to 12c are graphs illustrating reflection coefficient characteristics of an antenna according to the invention similar to that shown in FIG. 6.

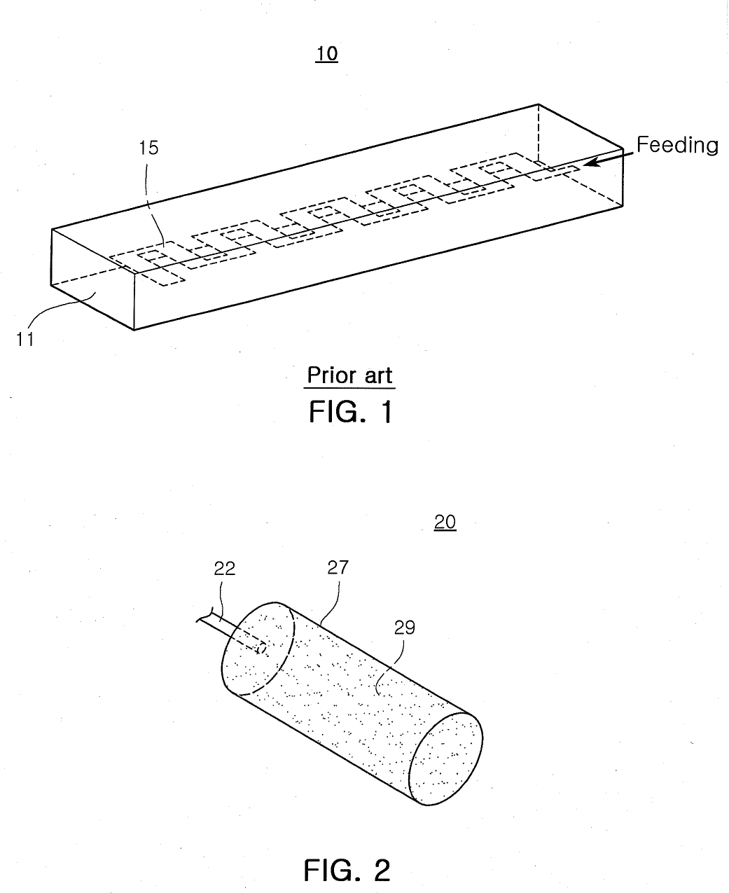

### DETAILED DESCRIPTION OF THE PREFERRED EMBODIMENT

The present invention will now be described more fully hereinafter with reference to the accompanying drawings, in which preferred embodiments of the invention are shown.

FIG. 2 is a schematic perspective view illustrating an antenna 20 incorporating a liquid radiator according to the invention.

Referring to FIG. 2, the antenna 20 includes polar liquid 29, an insulated container 27 for containing the polar liquid 29 and a feeder 22 connected to the polar liquid 29 contained inside the container 27.

The polar liquid 29 adopted as a novel radiator in this invention has a larger dielectric constant and a smaller Coulomb force, and thus is ionized more easily than non-polar solution such as hexane, pentane and benzene. The polar liquid 29 also has a strong tendency to interact with solute as well as large salvation energy, and thus can easily solve solute. Examples of the polar liquid 29 of this invention may include but not limited to water, methanol, ethanol, butanol, acetonitril, acetone, SAR solution and mixtures thereof.

The polar liquid 29 has a low but uniform electric conductivity and a high dielectric constant, and thus has various current distributions. As a result, the polar liquid 29 can act as a radiator in a specific resonant frequency by a current supplied through the feeder 22.

For example, it is known that water has a dielectric constant of about 80 and an electric conductivity of about 3 S/m, which are unique electromagnetic properties distinct from typical dielectric materials and metallic conductors. The inventors have observed that polar liquid such as water achieves a wideband and/or low-band use which cannot be expected from conventional antennas.

Furthermore, the polar liquid 25 can solve specific types of electrolyte to increase dissociated ions, thereby raising electric conductivity. Then, frequency can be easily adjusted through such a simple process of solving electrolyte. Alternatively, similar effects can be obtained by mixing conductor powder attractable by magnetic force into liquid in place of electrolyte. Illustrative examples of such conductor may include metal such as Fe.

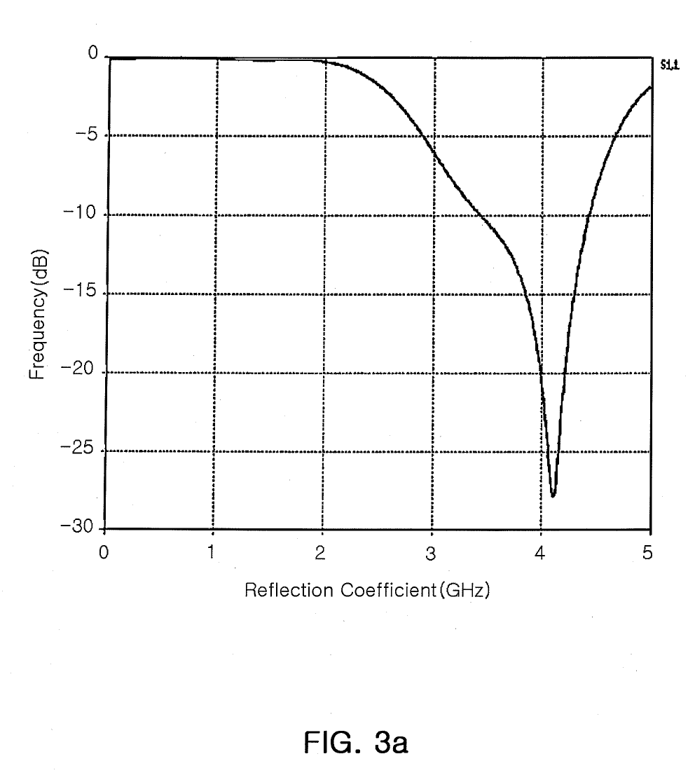

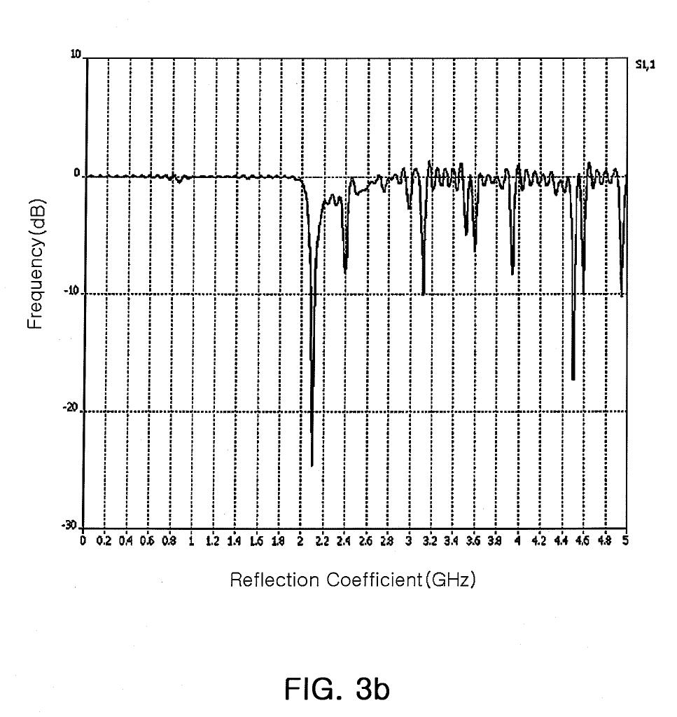

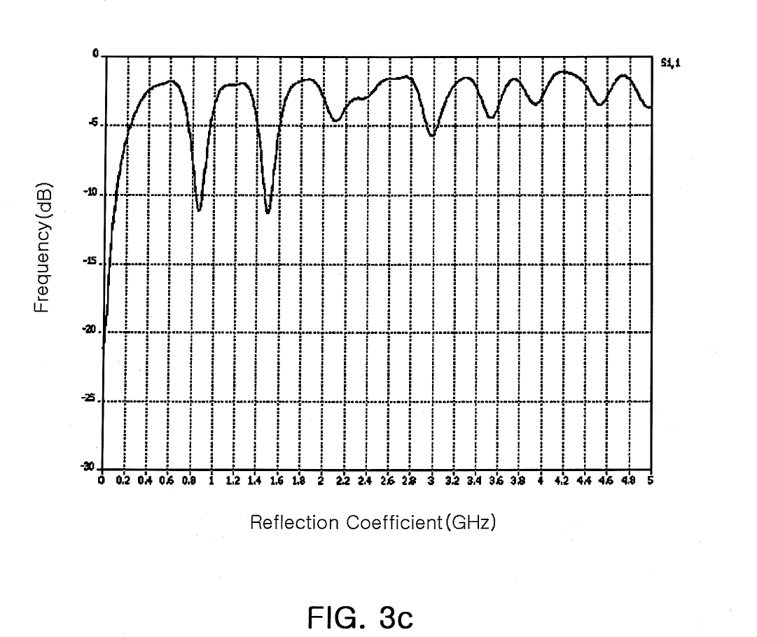

FIGS. 3a to 3c are simulation results for explaining operations and effects of the invention.

FIG. 3a shows a result obtained by calculating reflection coefficients of a cylindrical container as shown in FIG. 2, connected with a feeder. Here, the cylindrical container is filled with air only. If the filler is only composed of air (εᵣ=1) as in FIG. 3a, the resonant frequency was about 4.1 GHz and a reflection coefficient range not exceeding −10 dB was 3.4 to 4.4 GHz with a bandwidth of about 1 GHz.

FIG. 3b shows a result obtained by filling a solid dielectric material having a dielectric constant (εᵣ=80) similar to that of water into the same cylindrical container, and then by calculating reflection coefficients in the same method. In FIG. 3b, the resonant frequency was about 2.1 GHz and a reflection coefficient range not exceeding −10 dB was 2.07 to 2.11 GHz with a bandwidth of about 0.04 GHz.

Then, on the assumption that a material such as SAR solution having a dielectric constant (εᵣ=80) and an electric conductivity (0.8 s/m) is filled into the same cylindrical container, reflection coefficients were calculated. According to results in FIG. 3c, the resonant frequency was about 0.87 GHz and a reflection coefficient range not exceeding −10 dB was 0.831 to 0.894 GHz with a bandwidth of about 0.056 GHz.

It was observed that polar liquid such as SAR solution having a high dielectric constant and a low electric conductivity adopted as a radiator can achieve the resonant frequency in a low band and/or in a wide band.

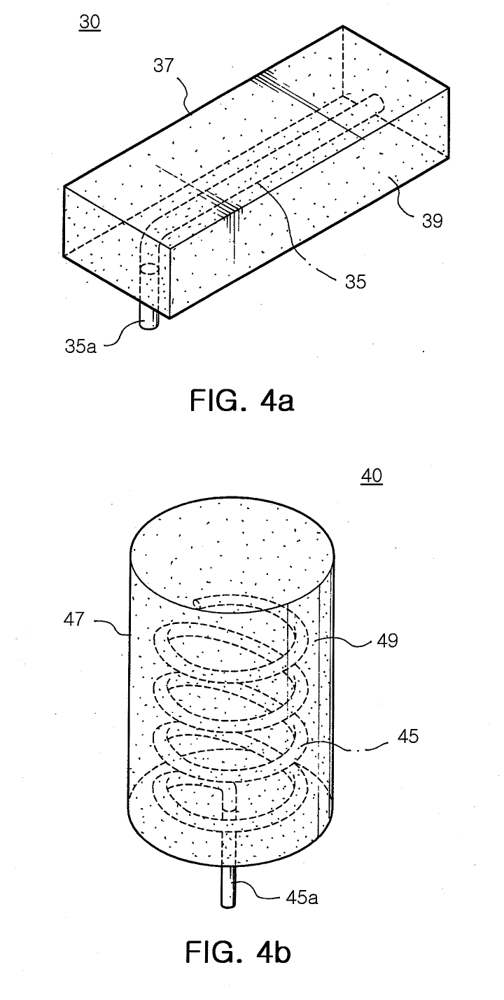

FIG. 4a is a schematic perspective view illustrating a monopole antenna 30 according to an embodiment of the invention.

Referring to FIG. 4a, the monopole antenna 30 is shown including an L-shaped radiator 35. The radiator 35 has one end forming a feeder 35a connected to an outer circuit.

In this embodiment, the radiator 35 of the monopole antenna 30 is arranged inside an insulated container 37. Polar liquid 39 is filled inside the insulated container 37.

As described earlier, the polar liquid 39 adoptable in this invention has a uniform electric conductivity and a high dielectric constant owing to ion bonding or molecular bonding as mentioned earlier. Examples of the polar liquid 39 of this invention may include but not limited to water, methanol, ethanol, butanol, acetonitril, acetone, SAR solution and mixtures thereof. The polar liquid 39 can additionally provide various current distributions that affect the properties of the antenna 30, thereby changing the resonant frequency of the radiator 35.

As stated earlier, the polar liquid 39 has a higher dielectric constant but a lower conductivity than a typical dielectric material or a conductive material such as metal, and thus affects the resonant frequency to be adjustable in a wide band (see Examples below) unlike the dielectric material or metal.

In a conventional monopole antenna, a conductive radiator has been extended in length or changed in geometry in order to change the resonant frequency. However, this invention can ensure use in a wide band as well as desirable resonant frequency change by adopting the polar liquid 39.

In case of adjusting the resonant frequency of an antenna by using polar liquid according to the invention, it is possible to selectively achieve the resonant frequency of the antenna in a low band and/or in a wide band according to the antenna structure. For example, from the L-shaped monopole wire antenna as shown in FIG. 4a, it may be expected that the resonant frequency is realizable in a low band. On the other hand, the helical antennal as shown in FIG. 4b is applicable to a wideband use.

Referring to FIG. 4b, a helical antenna 40 is shown including a helical radiator 45 which has one end forming into a feeder 45a connected to an outer circuit.

Likewise to FIG. 4a, the radiator 45 of the helical antenna 40 is arranged inside an insulated container 47. Polar liquid 39 is filled inside the insulated container 37. In this embodiment also, the polar liquid 49 can provide new current distributions based on its own electromagnetic properties, thereby changing unique resonant frequency of the radiator 45.

As stated earlier, the resonant frequency of the helical antenna 40 can be adjusted according to the spacing between loops of the helical radiator 45. Owing to such structural characteristics, the polar liquid 49 exerts electromagnetic influence between the loops, thereby achieving the resonant frequency in a wide band and to a high band.

In FIGS. 4a and 4b, it has been illustrated that the entire portion of the radiator is housed in the insulated container so that the polar liquid gives electromagnetic influence to the whole radiation area. The polar liquid contained in the insulated container may be modified into a structure that gives electromagnetic influence to at least a portion of the radiator. That is, only a portion of the radiator may be arranged inside a liquid container or the liquid container may be arranged adjacent to the radiator.

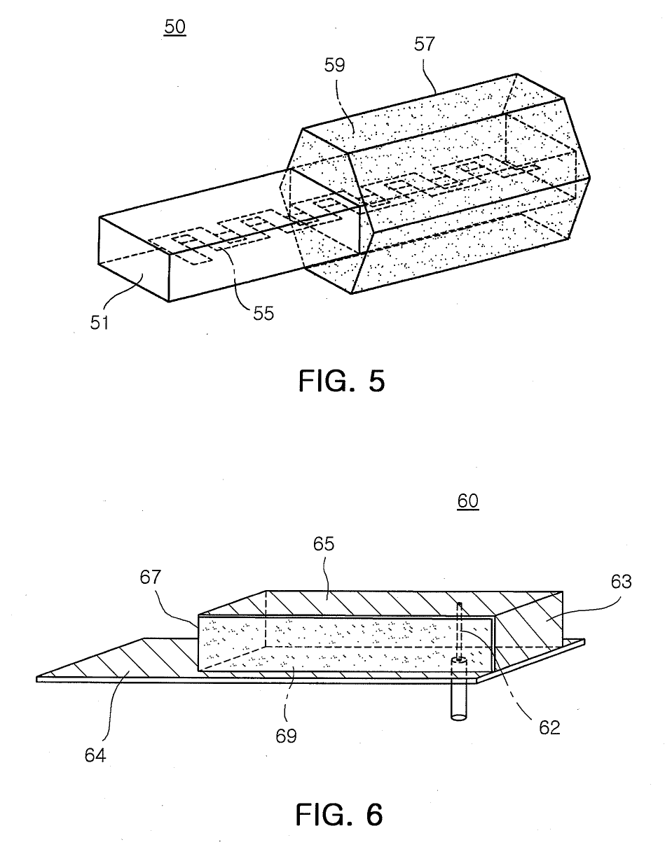

FIG. 5 is a schematic perspective view illustrating a liquid-coupled chip antenna 50 according to the invention.

As shown in FIG. 5, the chip antenna 50 having a microstrip structure includes a dielectric block 51, a conductor pattern 55 in the form of a meander line, an insulated container 57 receiving a portion of the dielectric block 51 and polar liquid 59 filled in the insulated container 57.

While the chip antenna 50 has a unique resonant frequency determined according to the resonant length of the conductor pattern 55, the resonant frequency is changed according to the polar liquid contained inside the container 57. That is, the polar liquid 59 gives electromagnetic influence to the conductor pattern 55, which acts as a radiator, thereby realizing the resonant frequency in a low band and/or in a wide band.

Even if the polar liquid 59 partially contacts the radiator or the conductor pattern 55, the polar liquid 59 gives electromagnetic influence to its radiation area, thereby changing the current resonant frequency. In particular, the polar liquid 59 has generally a high dielectric constant and a low conductivity, thereby potentially realizing the resonant frequency in a low band and/or in a wide band.

This as a result makes it possible to easily and effectively change the resonant frequency of the chip antenna by using the polar liquid 59 unlike in a conventional chip antenna where the conductor pattern is prolonged or geometrically reshaped in order to change the resonant frequency.

In this embodiment, it is possible to add electrolyte or conductor powder into the polar liquid adopted as a means for changing the resonant frequency, thereby changing electromagnetic characteristics thereof. Therefore, the resonant frequency of the polar liquid can be adjusted variously according to the type and amount of conductor powder or electrolyte. Such electrolyte may adopt various examples, which include binary electrolyte such as NaCl, ternary electrolyte such as K₂SO₄, acid or alkaline electrolyte and polyelectrolyte. Examples of the conductor powder may include powder of metals attractable by magnetic force such as Fe and Ni.

In the antenna adopting the resonant frequency-adjusting means of the invention, the chip antenna may be modified in its structure. For example, the polar liquid may be embodied to replace a dielectric block. In this case, a radiator is formed on the surface of an insulated container that contains the polar liquid as shown in FIG. 6.

FIG. 6 illustrates a Planar Inverted-F Antenna (PIFA) structure chip antenna 60 formed on a ground plate 64 as an example of a chip antenna with a resonant frequency-adjusting means of the invention applied thereto.

Referring to FIG. 6, the chip antenna 60 includes a radiating electrode 65 connected to a feeder 62. The radiating electrode 65 has a PIFA structure with a short-circuit part 63 connected to a ground plate 64.

In this embodiment, the insulated container 67 filled with polar liquid 69 is adopted as a structure replacing a conventional dielectric block. That is, a conductor pattern including the radiating electrode 65 is formed on the surface of the insulated container 67.

The polar electrode 69 has a high dielectric constant together with a certain conductivity based on ion or molecular bonding, thereby changing current distribution of the radiating electrode 65. This as a result can adjust the unique resonant frequency of the radiating electrode 65.

Referring to following Examples, operations and effects of the antenna of the invention will be described in detail.

### EXAMPLE 1

First, three (3) antenna structures were fabricated each by preparing a cylindrical container and installing a feeder line to be connected into the container under the same conditions, in which each cylindrical container had a volume of about 4.5 ml and the feeder line was a copper line about 1.8 cm long.

Then, the cylindrical container of the first antenna structure was filled only with the air without any other materials, the cylindrical container of the second antenna structure was filled up with water, and the cylindrical container of the third antenna structure was filled up with SAR solution (dielectric constant of 80, conductivity of 0.8 s/m).

By supplying a certain value of current to the feeder of the first to third antenna structures fabricated as above, reflection coefficients and radiation patterns were measured.

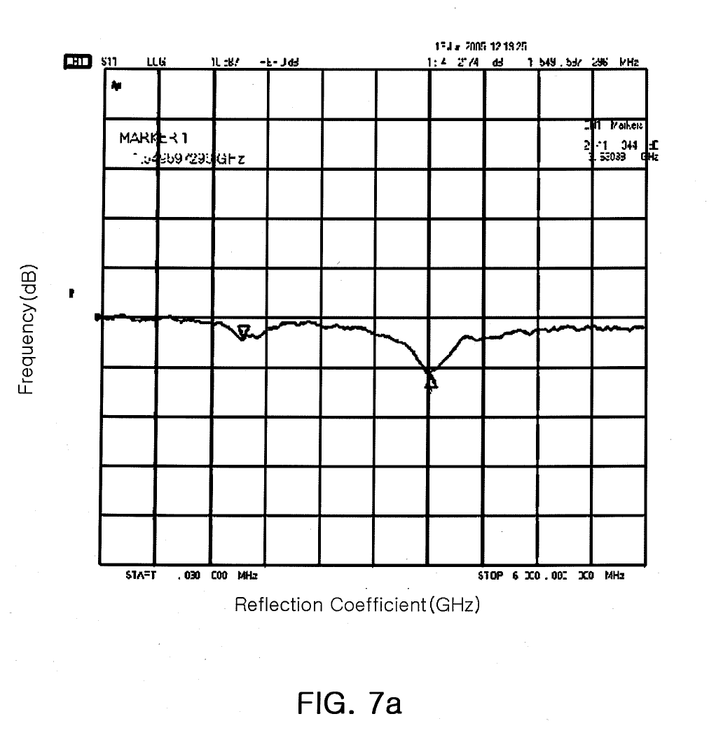

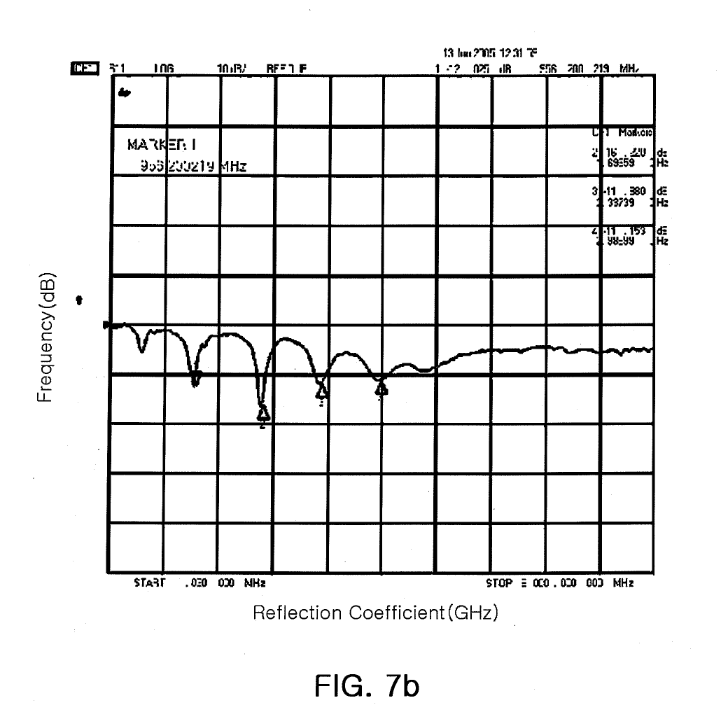

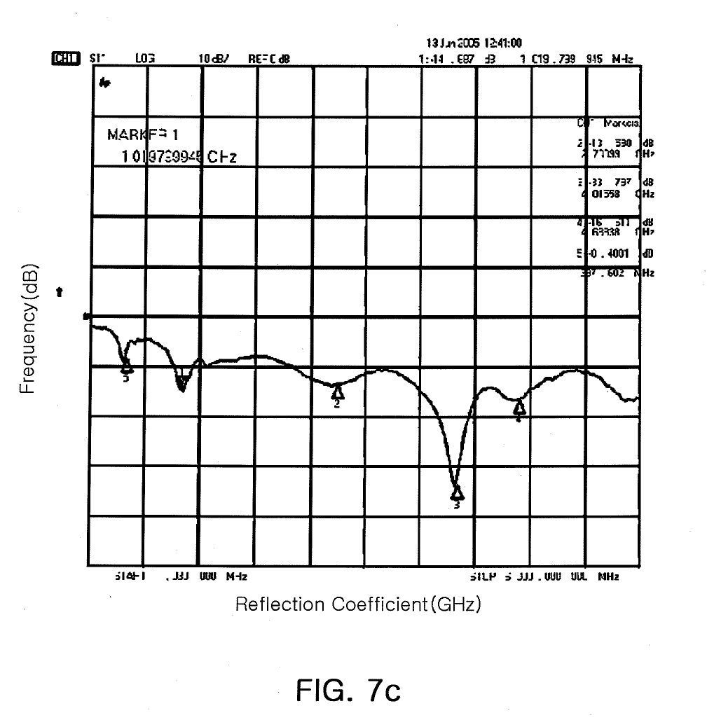

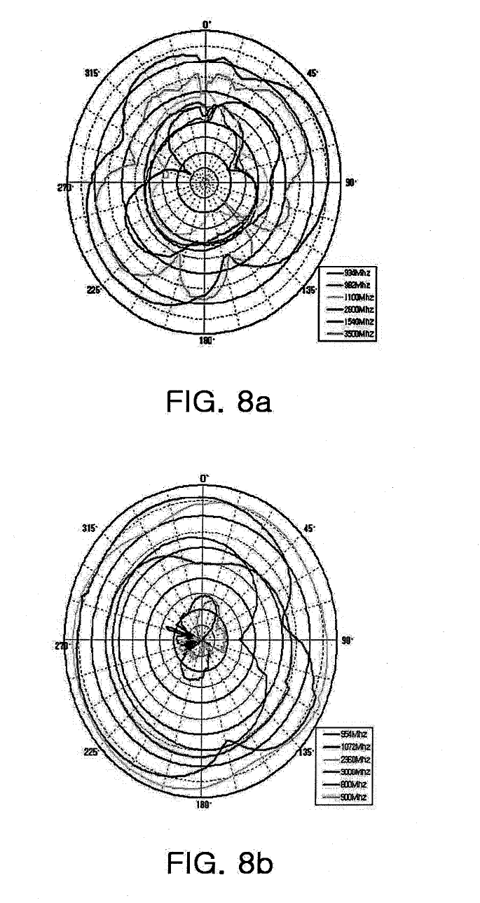

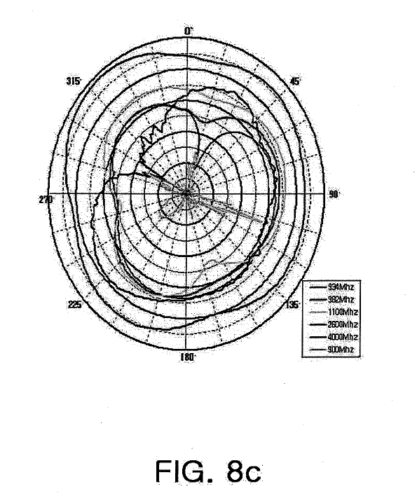

FIGS. 7a to 7c are graphs illustrating reflection coefficient characteristics of the antennas fabricated according to Example 1 above, and FIGS. 8a to 8b are graphs illustrating radiation patterns of the antennas fabricated according to Example 1 above.

Examining FIGS. 7b and 7c in comparison with FIG. 7a, it was observed that the second and third antennas adopting the water or SAR solution as a radiator had various resonant frequencies. These results show that the polar liquid when used as a radiator can achieve wideband use in a high level. It was also confirmed that the second and third antennas had a resonant frequency also in a low band of 1 GHz or less.

As such, the resonant frequency was changed variously even in the same antenna structure according to the material filled in the container. In particular, it was confirmed that it is possible to obtain the resonant frequency in a low band and/or in a wide band by using the polar liquid such as the water and SAR solution a radiator.

In addition, radiation patterns and gains were also measured on the antenna structures fabricated as above in order to determine applicability as an antenna, and their results are reported in FIGS. 8a to 8c. It was confirmed that more various radiation characteristics were observed from the second and third antenna structures (see FIGS. 8b and 8c) than the first antenna structure merely filled with air (see FIG. 8a). In particular, examining the gains, the second antenna filled with the water and the third antenna filled with SAR solution showed a relatively high gain of about −4 to 8.6 dBi in the resonant frequency as shown in FIGS. 7b and 7c.

As above, the antenna adopting polar liquid as a radiator was confirmed of its applicability as a low-band and/or wideband antenna.

The antenna incorporating polar liquid of the invention has merits in that electrolyte such as NaCl or conductor powder can be mixed into the polar liquid adopted as a radiator to easily change antenna characteristics. Furthermore, different resonant frequency characteristics can be obtained according to the features of the polar liquid.

### EXAMPLE 2

Example 2 was performed to confirm that various types of polar liquid each have a unique resonant frequency.

An antenna structure was fabricated by preparing a cylindrical container, installing a feeder line to be connected into the cylindrical container, and filling carbonated water in the cylindrical container under the same conditions as in Example 1. Then, its reflection coefficients and radiation characteristics were measured.

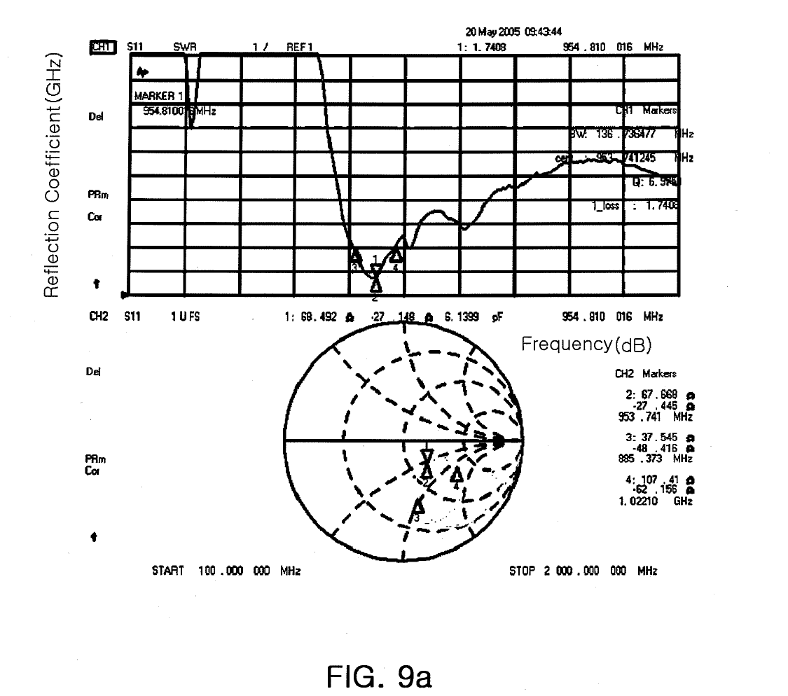

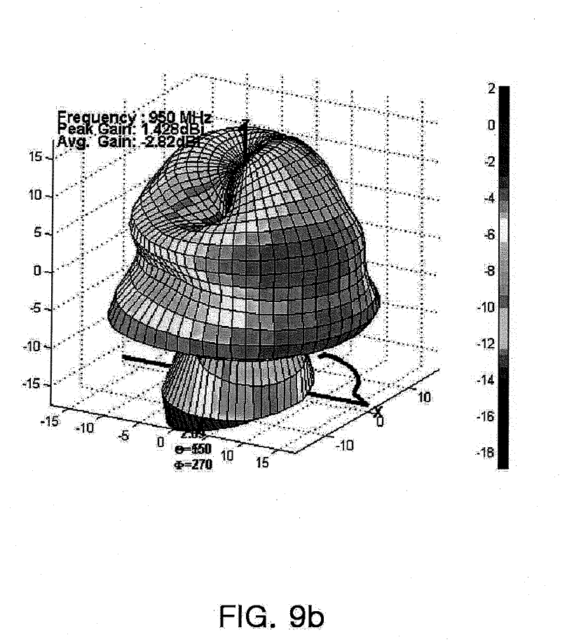

FIGS. 9a and 9b are graphs illustrating reflection coefficient characteristics and a radiation pattern of the antenna of Example 2 where carbonated water was used as a radiator.

As seen in FIG. 9a, the resonant frequency was very low, i.e., about 950 MHz, and a frequency range not exceeding a specific reflection coefficient was observed in a wide range. In addition, as seen in FIG. 9b, various radiation characteristics were observed with a maximum gain of about 1.42 dBi and an average gain of about −2.82 dBi. As such, the antenna of Example 2 was confirmed applicable as a low-band and/or wideband antenna with excellent gains.

### EXAMPLE 3

Example 3 was performed to observe changes in the resonant frequency when a resonant frequency-adjusting means using polar liquid is combined with a monopole antenna.

An L-shaped wire monopole antenna designed to have a resonant frequency of about 4.27 GHz was fabricated, which had a configuration similar to that shown in FIG. 4a. The monopole antenna was surrounded by a liquid container of 10.5 ml to provide a desired antenna device.

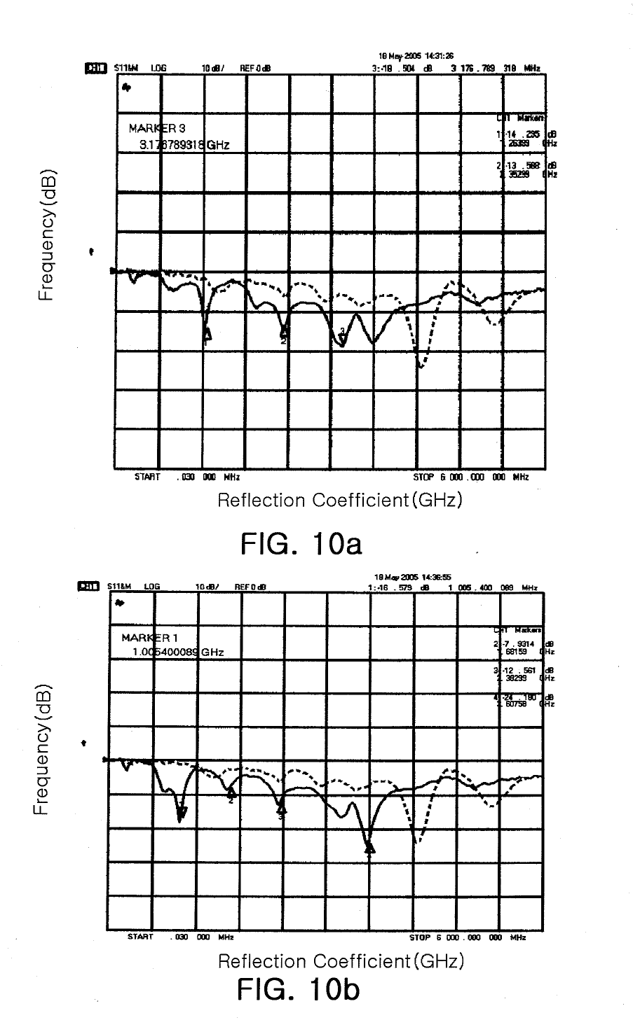

First, reflection coefficient characteristics were measured on the antenna in a state that the insulated container was vacant, that is, filled only with the air. Measurement results are shown with dotted lines in the graphs of FIGS. 10a and 10b.

Water was filled up as a polar liquid in the insulated container, and then reflection coefficients were measured on the antenna. The results are shown in FIG. 10a. Next, Fe powder of about 5 g was added into the insulated container, and then reflection coefficients were measured on the antenna with the results shown in FIG. 10b.

Referring to FIG. 10a, a resonant frequency range was observed in a wider band. In addition, as stated earlier, it can be seen that the resonant frequency was realized in a rather lower band.

Likewise, referring to FIG. 10b, it can be seen that the realization of the resonant frequency in a wide band and in a low band was more significant than the result of FIG. 10a (where merely the water was used). This can be understood that Fe powder exerted additional electromagnetic influence in the water acting as a polar liquid.

### EXAMPLE 4

Example 4 was performed to observe any change in the resonant frequency of a helical antenna which adopts polar liquid as a resonant frequency-adjusting means.

A helical antenna designed to have resonant frequencies of about 1.25 GHz and 3.73 GHz was fabricated, which had a helical radiator similar to that shown in FIG. 4b. The helical antenna was surrounded by a liquid container of 10.5 ml as in Example 3 above.

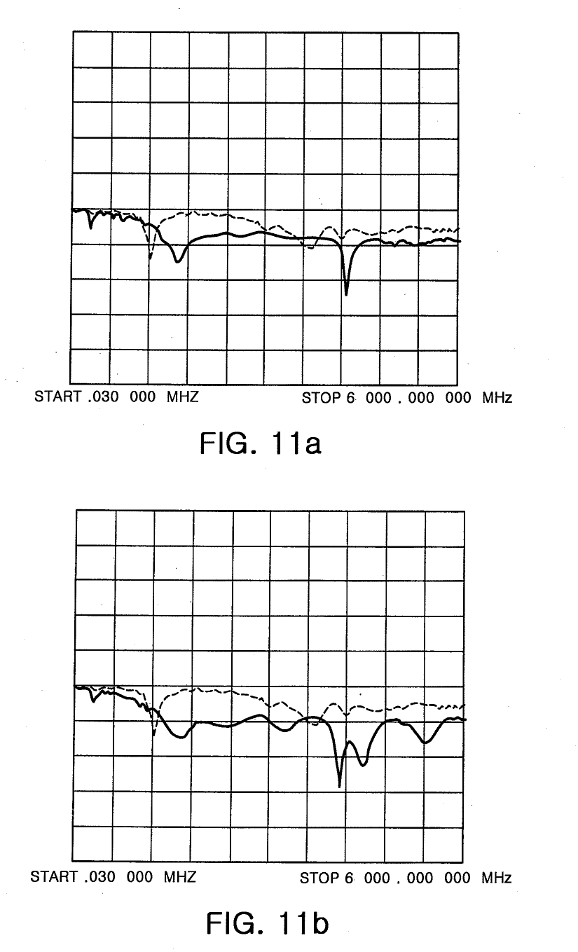

First, reflection coefficient characteristics were measured on the antenna in a state that the insulated container was vacant, that is, filled only with air. Measurement results are shown with dotted lines in the graphs of FIGS. 11a and 11b.

Water was filled up as a polar liquid in the insulated container, and then reflection coefficients were measured on the antenna with the results shown in FIG. 11a. Next, water was removed from the insulated container, and a mixed solution of hydrogen peroxide and 5 g Ni was filled in the insulated container. Then, reflection coefficients were measured on the antenna with the results shown in FIG. 11b.

Referring to FIG. 11a, the resonant frequencies were obtained generally in a wide band, and particularly, 1.67 GHz and 4.31 GHz. That is, unlike the results measured in Example 1, the resonant frequencies were realized in a higher band than those measured without any resonant frequency-adjusting means. Accordingly, it was found that the resonant frequency-adjusting means of the invention have different tendency according to the antenna structure.

Likewise, referring to FIG. 11b, it was observed that the realization of the resonant frequency in a wide band and in a low band was more significant than the result of FIG. 11a (where merely the water was used). In particular, in case of using hydrogen peroxide and Ni electrolyte as a polar liquid, the effect for the wide band was more significant. As such, according to this disclosure of the invention, the degree of change in the resonance frequency of the antenna can be adjusted according to the type of polar liquid and additives.

### EXAMPLE 5

Example 5 was performed to observe resonant frequency adjustment effect using polar liquid according to the invention. In Example 5, chip antennas configured similar to that of FIG. 6 were fabricated, and their reflection coefficient characteristics were measured by simulation.

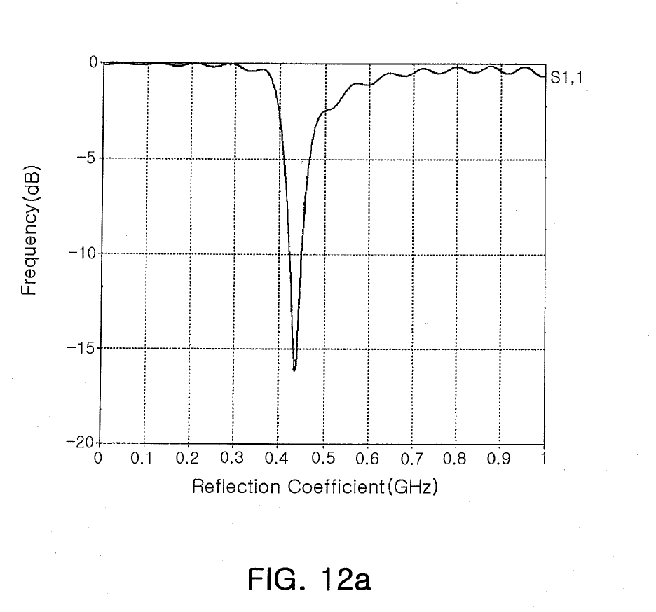

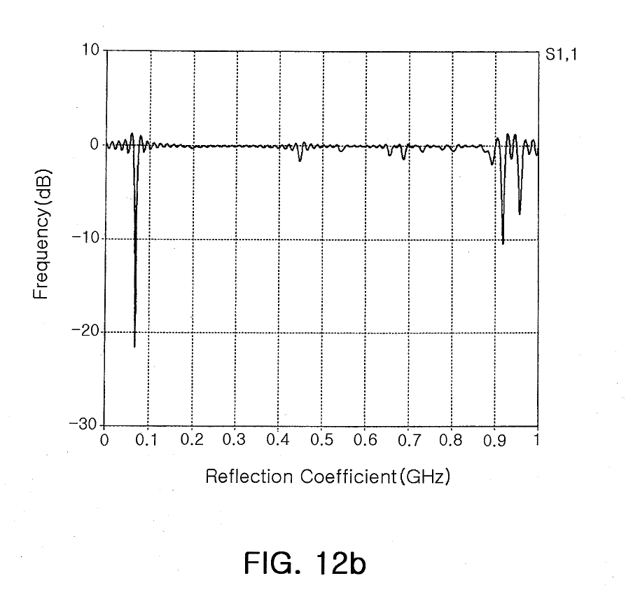

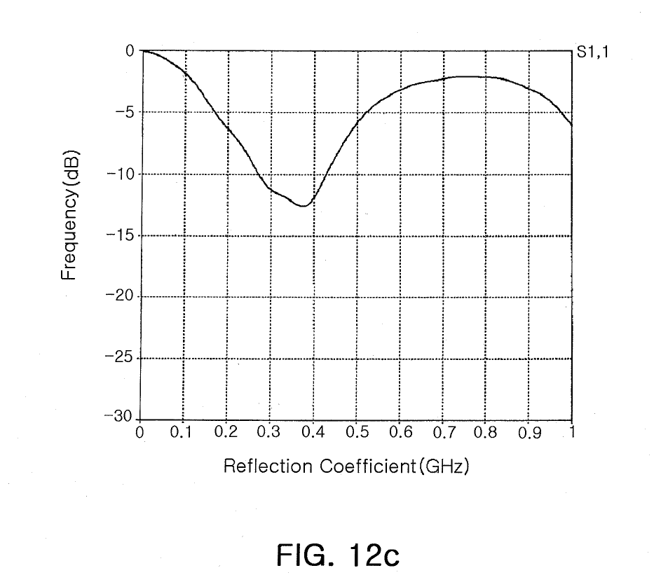

First, reflection coefficients were measured on one of the chip antennas configured similar to that of FIG. 6 but without polar liquid or an insulated container, that is, in a condition that only the air existed under the radiating electrode. Results are shown in FIG. 12a, in which a resonant frequency was of about 434 MHz, a reflection coefficient range not exceeding −10 dB was about 420 to 450 MHz with a bandwidth of about 30 MHz.

Then, a solid dielectric material such a typical dielectric block was introduced. In order to compare effects with those of a polar liquid, the dielectric block had a dielectric constant the same as that of the polar liquid to be used (SAR solution). When measurement was made on the antenna adopting the dielectric block, as shown in FIG. 12b, it was observed that the resonant frequency was about 68 MHz, and a bandwidth with a reflection coefficient not exceeding −10 dB was about 3 MHz, which was narrowed significantly. These results can be understood that the use of the typical dielectric block caused the chip antenna to have a narrow band.

Finally, a liquid container having the same shape and size as those of the dielectric block was arranged in the position of the dielectric block, and SAR solution (dielectric constant of 80, electric conductivity of 0.8 s/m) was filled into the container to produce an antenna of the invention. Then, reflection coefficients were measured on this antenna. As shown in FIG. 12c, the resonant frequency was about 368 MHz, a reflection coefficient range not exceeding −10 dB was 268 to 430 MHz with a bandwidth of about 162 MHz. By using the polar liquid as above, the bandwidth was lowered for at least 10%. Furthermore, when compared with FIG. 12b showing the results similar to those of a typical chip antenna, it was found that the bandwidth was greater at least 50 times.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

As set forth above, certain embodiments of the present invention provide a novel structure of antenna which incorporates polar liquid as a radiator. Such an antenna can realize the resonant frequency in a low band and/or a wide band which cannot be expected from conventional antennas having a conductive radiator. Furthermore, antenna characteristics can be designed variously based on the compositions of polar liquid, the concentrations and types of electrolyte and contents and types of conductor powder.

Moreover, a novel antenna structure of certain embodiments of the invention can be combined with a conventional antenna structure to realize the resonant frequency in a wide band as well as in a low or high band. Accordingly, the resonant frequency of the antenna can be easily adjusted without extending the length of a conductor pattern or changing the geometry thereof.

What is claimed is:

1. An antenna comprising:
a polar liquid;
a container made of an insulating material, the container containing the polar liquid; and
a feeder connected to the polar liquid contained in the container,
whereby the polar liquid acts as a radiator.

2. The antenna according to claim 1, wherein the polar liquid comprises one selected from the group consisting of water, methanol, ethanol, butanol, acetonitril, acetone, SAR solution and mixtures thereof.

3. The antenna according to claim 1, wherein the polar liquid comprises an electrolyte solution with at least one type of electrolyte solved therein.

4. The antenna according to claim 1, wherein the polar liquid contains conductor powder that is attractable by magnetic force.

5. The antenna according to claim 4, wherein the conductor powder comprises Fe.

6. A wideband antenna comprising:
a radiator constructed of a conductor having an electrical resonant length corresponding to a unique resonant frequency, the radiator having a feeder at one end connected to an outer circuit;
a container made of an insulating material, the container containing at least a portion of the radiator therein or disposed adjacent to a portion of the radiator; and
a polar liquid contained inside the container, the polar liquid affecting electromagnetic flow of the radiator in order to change the unique resonant frequency of the radiator.

7. The wideband antenna according to claim 6, wherein the whole part of the radiator is arranged inside the container.

8. The wideband antenna according to claim 6, wherein the radiator is helical, and
wherein the polar liquid enables the antenna to have a resonant frequency higher than unique resonant frequency of the radiator.

9. The wideband antenna according to claim 6, wherein the radiator has a monopole configuration, and
wherein the polar liquid enables the antenna to have a resonant frequency higher than unique resonant frequency of the radiator.

10. The wideband antenna according to claim 6, wherein the wideband antenna is a chip antenna, and wherein the container is shaped to surround at least a portion of the chip antenna.

11. The wideband antenna according to claim 6, wherein the conductor of the radiator is formed on a surface of the container.

12. The wideband antenna according to claim 6, wherein the polar liquid comprises one selected from the group consisting of water, methanol, ethanol, butanol, acetonitril, acetone, SAR solution and mixtures thereof.

13. The wideband antenna according to claim 6, wherein the polar liquid comprises an electrolyte solution with at least one type of electrolyte solved therein.

14. The wideband antenna according to claim 6, wherein the polar liquid contains conductor powder that is attractable by magnetic force.
